(19) United States
(12) Patent Application Publication
(10) Pub. No.: US 2026/0205027 A1
(43) Pub. Date: Jul. 16, 2026

(54) REGULATING RECTIFIER WITH ADAPTIVE CURRENT BOOSTING AND OPERATION METHOD THEREOF

(71) Applicant: Novatek Microelectronics Corp., Hsinchu (TW)

(72) Inventors: Tzu-Ning Liu, Kaohsiung City (TW); Wen-Po Lo, Taichung City (TW); Po-Hung Chen, Hsinchu County (TW); Yi-An Ai, Hsinchu City (TW); Chi-Wei Liu, Taipei City (TW)

(73) Assignee: Novatek Microelectronics Corp., Hsinchu (TW)

(21) Appl. No.: 19/067,970

(22) Filed: Mar. 2, 2025

(30) Foreign Application Priority Data
Jan. 16, 2025 (TW) 114101801

(51) Int. Cl. H02J 50/10; H02J 7/34; H02M 7/219; H02M 1/08

(52) U.S. Cl. CPC H02J 50/10; H02J 7/345; H02M 7/219; H02M 7/2195; H02J 2207/20; H02J 2207/50; H02M 1/08

(57) ABSTRACT

A regulating rectifier and an operation method thereof are provided. A regulating rectifier includes an output switch circuit, an energy storage switch circuit, an energy storage capacitor, and a crossbar switch circuit. In a charging mode, the output switch circuit and the crossbar switch circuit form a rectifier circuit together to convert wireless power received by a wireless charging induction coil into output power. In a current boosting mode, the output switch circuit, the energy storage switch circuit, and the crossbar switch circuit perform an iterative operation (including a direct current-direct current (DC-DC) conversion and an alternating current-direct current (AC-DC) conversion) together. The DC-DC conversion uses energy of the energy storage capacitor to perform current boosting on the wireless charging induction coil. The AC-DC conversion converts the wireless power of the wireless charging induction coil into the output power.

### CROSS-REFERENCE TO RELATED APPLICATION

This application claims the priority benefit of Taiwan application serial no. 114101801, filed on January 16, 2025. The entirety of the above-mentioned patent application is hereby incorporated by reference herein and made a part of this specification.

### BACKGROUND

### Technical Field

The disclosure relates to a power supply circuit, and particularly to a regulating rectifier with an adaptive current boosting function and an operation method thereof.

### Description of Related Art

Wireless charging technology has been widely applied in many fields. Taking electronic shelf labels as an example, when a charging device is used to wirelessly power the labels, the angle and distance of the charging device will affect the wireless charging energy received by the receivers (labels). That is, during the period when the charging device wirelessly powers a receiver, the wireless charging energy received by the wireless charging induction coil of the receiver may fluctuate. How to effectively use the wireless charging energy received by the wireless charging induction coil to provide a more stable supply voltage to other circuits of the receiver has become one of the many technical challenges in this field.

### SUMMARY

The disclosure provides a regulating rectifier and an operation method thereof to convert wireless power received by a wireless charging induction coil into output power.

In an embodiment of the disclosure, the regulating rectifier includes an output switch circuit, an energy storage switch circuit, an energy storage capacitor, and a crossbar switch circuit. A common terminal of the output switch circuit is coupled to an output terminal of the regulating rectifier. A first terminal and a second terminal of an input terminal pair of the regulating rectifier are respectively coupled to a first terminal and a second terminal of a wireless charging induction coil. A first selection terminal of the output switch circuit is coupled to the first terminal of the wireless charging sensing coil. A second selection terminal of the output switch circuit is coupled to the second terminal of the wireless charging induction coil. A first selection terminal of the energy storage switch circuit is coupled to the first terminal of the wireless charging induction coil. A second selection terminal of the energy storage switch circuit is coupled to the second terminal of the wireless charging induction coil. A first terminal of the energy storage capacitor is coupled to a common terminal of the energy storage switch circuit. A second terminal of the energy storage capacitor is coupled to a first reference voltage source. A first terminal of the crossbar switch circuit is coupled to the first terminal of the wireless charging induction coil. A second terminal of the crossbar switch circuit is coupled to the second terminal of the wireless charging induction coil. In response to the regulating rectifier operating in a charging mode, the output switch circuit and the crossbar switch circuit form a first rectifier circuit together to convert wireless power received by the wireless charging induction coil into output power for the output terminal of the regulating rectifier. In response to the regulating rectifier operating in a current boosting mode (CBM), the output switch circuit, the energy storage switch circuit, and the crossbar switch circuit perform an iterative operation together, where the iterative operation includes a direct current-direct current (DC-DC) conversion and an alternating current-direct current (AC-DC) conversion. The DC-DC conversion uses stored energy of the energy storage capacitor to perform current boosting on the wireless charging induction coil. The AC-DC conversion converts the wireless power of the wireless charging induction coil into the output power for the output terminal of the regulating rectifier.

In an embodiment of the disclosure, the operation method includes the following steps. In response to a regulating rectifier operating in a charging mode, an output switch circuit of the regulating rectifier and a crossbar switch circuit of the regulating rectifier form a first rectifier circuit to convert wireless power received by a wireless charging induction coil into output power for an output terminal of the regulating rectifier. Further, in response to the regulating rectifier operating in a current boosting mode, the output switch circuit, an energy storage switch circuit, and the crossbar switch circuit of the regulating rectifier perform an iterative operation, where the iterative operation includes a direct current-direct current (DC-DC) conversion and an alternating current-direct current (AC-DC) conversion. The DC-DC conversion uses stored energy of the energy storage capacitor to perform current boosting on the wireless charging induction coil. The AC-DC conversion converts the wireless power of the wireless charging induction coil into the output power for the output terminal of the regulating rectifier.

Based on the above, in the embodiments of the disclosure, the regulating rectifier may operate in a plurality of modes, such as the charging mode and the current boosting mode. During the period when the charging device wirelessly powers a receiver, the wireless power received by the wireless charging induction coil of the receiver may fluctuate. When the wireless power received by the wireless charging induction coil is sufficiently large, the regulating circuit operates in the charging mode to convert the wireless power received by the wireless charging induction coil into the output power for other circuits (load circuit) of the receiver. When the wireless power received by the wireless charging induction coil becomes weak, the regulating rectifier operates in the current boosting mode to perform the iterative operation, such as the DC-DC conversion and the AC-DC conversion. The current boosting mode uses the stored energy of the energy storage capacitor to perform current boosting on the wireless charging induction coil (transferring the energy of the energy storage capacitor to the wireless charging induction coil) and then convert the boosted power of the wireless charging induction coil into the output power. Therefore, the regulating rectifier is able to effectively use the wireless charging power received by the wireless charging induction coil and thereby provides a stable power supply voltage to other circuits of the receiver.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic circuit block diagram of a wireless power receiver according to an embodiment of the disclosure.

FIG. 2 is a schematic circuit block diagram of a regulating rectifier according to an embodiment of the disclosure.

FIG. 3 is a schematic flow chart of an operation method of the regulating rectifier according to an embodiment of the disclosure.

FIG. 4 is a schematic circuit diagram illustrating an output switch circuit, an energy storage switch circuit, and a crossbar switch circuit according to an embodiment of the disclosure.

FIG. 5 is a waveform graph illustrating voltages in different operation modes according to an embodiment of the disclosure.

FIG. 6 is a waveform graph illustrating voltages in a current boosting mode according to an embodiment of the disclosure.

### DESCRIPTION OF THE EMBODIMENTS

The term "coupled to (or connected to)" used in the entire specification (including claims) refers to any direct or indirect connecting means. For instance, if the disclosure describes a first apparatus is coupled to (or connected to) a second apparatus, the description should be explained as the first apparatus is connected directly to the second apparatus, or the first apparatus, through connecting other apparatus or using certain connecting means, is connected indirectly to the second apparatus. In addition, terms such as "first" and "second" in the entire specification (including claims) are used only to name the elements or to distinguish different embodiments or scopes and should not be construed as the upper limit or lower limit of the number of elements and should not be construed to limit the order of the elements. Moreover, elements/components/steps with the same reference numerals represent the same or similar parts in the figures and embodiments where appropriate. Elements/components/steps having same reference numerals or same terms are used as cross reference in different embodiments.

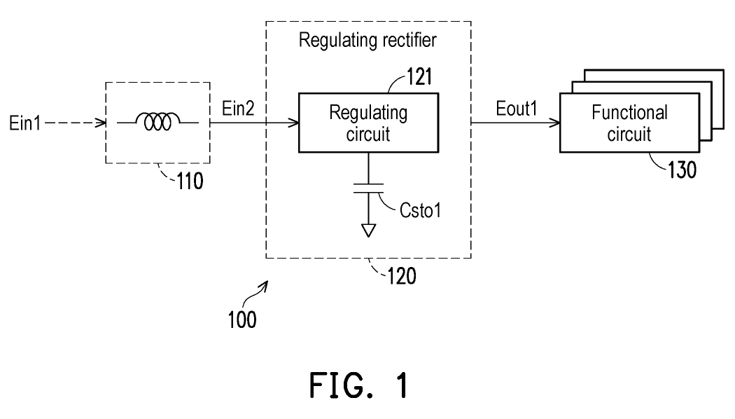

FIG. 1 is a schematic circuit block diagram of a wireless power receiver 100 according to an embodiment of the disclosure. The wireless power receiver 100 may be applied to various electronic products. Taking electronic shelf application as an example (but not limited thereto), the wireless power receiver 100 may be an electronic shelf label. The wireless power receiver 100 shown in FIG. 1 includes a wireless charging induction coil 110, a regulating rectifier 120, and a functional circuit 130 (load circuit). The regulating rectifier 120 may supply power to the functional circuit 130. A charging device (not shown) transmits wireless charging energy Ein1 to the wireless power receiver 100. When the charging device transmits the wireless charging energy Ein1, the wireless charging induction coil 110 may sense the wireless charging energy Ein1 from the charging device and generate wireless power Ein2 to the regulating rectifier 120. The regulating rectifier 120 converts the wireless power Ein2 from the wireless charging induction coil 110 into output power Eout1 for the functional circuit 130.

The regulating rectifier 120 may operate in a plurality of modes, such as but not limited to a charging mode and a current boosting mode. In the embodiment shown in FIG. 1, the regulating rectifier 120 includes a regulating circuit 121 and an energy storage capacitor Csto1. When the wireless charging energy Ein1 received by the wireless charging induction coil 110 is sufficiently large, the regulating circuit 121 may operate in the charging mode to convert the wireless power Ein2 from the wireless charging induction coil 110 into the output power Eout1 for the functional circuit 130. An angle and a distance of a charging device (not shown) relative to the wireless power receiver 100 affects the wireless charging energy Ein1 received by the wireless charging induction coil 110. In other words, the wireless charging energy Ein1 received by the wireless charging induction coil 110 may fluctuate. When the wireless charging energy Ein1 received by the wireless charging induction coil 110 is sufficiently large, the regulating circuit 121 may also store the wireless power Ein2 from the wireless charging induction coil 110 in the energy storage capacitor Csto1. When the wireless charging energy Ein1 received by the wireless charging induction coil 110 becomes weak, the regulating circuit 121 may operate in the current boosting mode to perform an iterative operation. The iterative operation may use stored energy of the energy storage capacitor Csto1 to perform current boosting on the wireless charging induction coil 110 (i.e., transfer the energy from the energy storage capacitor Csto1 to the wireless charging induction coil 110) and then convert the enhanced energy of the wireless charging induction coil 110 into the output power Eout1 for the functional circuit 130. Therefore, the regulating rectifier 120 may effectively use the wireless charging energy Ein1 received by the wireless charging induction coil 110 and thereby provides a stable power supply voltage to the functional circuit 130.

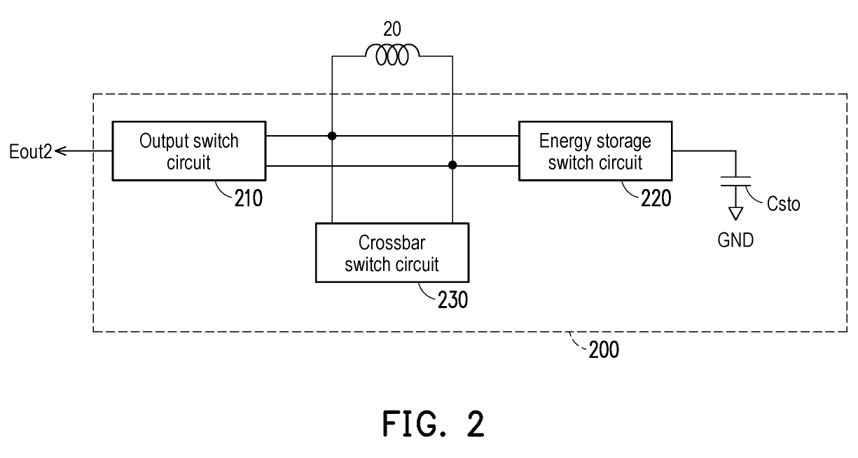

FIG. 2 is a schematic circuit block diagram of a regulating rectifier 200 according to an embodiment of the disclosure. A first terminal and a second terminal of an input terminal pair of the regulating rectifier 200 are respectively coupled to a first terminal and a second terminal of a wireless charging induction coil 20. The wireless charging induction coil 20 and the regulating rectifier 200 shown in FIG. 2 may be understood by analogy with reference to the related description of the wireless charging induction coil 110 and the regulating rectifier 120 shown in FIG. 1.

In the embodiment shown in FIG. 2, the regulating rectifier 200 includes an output switch circuit 210, an energy storage switch circuit 220, an energy storage capacitor Csto, and a crossbar switch circuit 230. The output switch circuit 210, the energy storage switch circuit 220, and the crossbar switch circuit 230 shown in FIG. 2 may act as one of many embodiments of the regulating circuit 121 shown in FIG. 1. The output switch circuit 210, the energy storage switch circuit 220, and the crossbar switch circuit 230 shown in FIG. 2 may be understood by analogy with reference to the related description of the regulating circuit 121 shown in FIG. 1.

A common terminal of the output switch circuit 210 is coupled to an output terminal of the regulating rectifier 200 to provide output power Eout2 to the load circuit (not shown). The output power Eout2 shown in FIG. 2 may be understood by analogy with reference to the related description of the output power Eout1 shown in FIG. 1, and therefore will not be described in detail herein. A first selection terminal of the output switch circuit 210 is coupled to the first terminal of the wireless charging induction coil 20. A second selection terminal of the output switch circuit 210 is coupled to the second terminal of the wireless charging induction coil 20.

A first selection terminal of the energy storage switch circuit 220 is coupled to the first terminal of the wireless charging induction coil 20. A second selection terminal of the energy storage switch circuit 220 is coupled to the second terminal of the wireless charging induction coil 20. A first terminal of the energy storage capacitor Csto is coupled to a common terminal of the energy storage switch circuit 220. A second terminal of the energy storage capacitor Csto is coupled to a reference voltage source (e.g., a ground voltage source GND). The energy storage capacitor Csto shown in FIG. 2 may be understood by analogy with reference to the related description of the energy storage capacitor Csto1 shown in FIG. 1, and therefore is not described in detail herein. A first terminal of the crossbar switch circuit 230 is coupled to the first terminal of the wireless charging induction coil 20. A second terminal of the crossbar switch circuit 230 is coupled to the second terminal of the wireless charging induction coil 20.

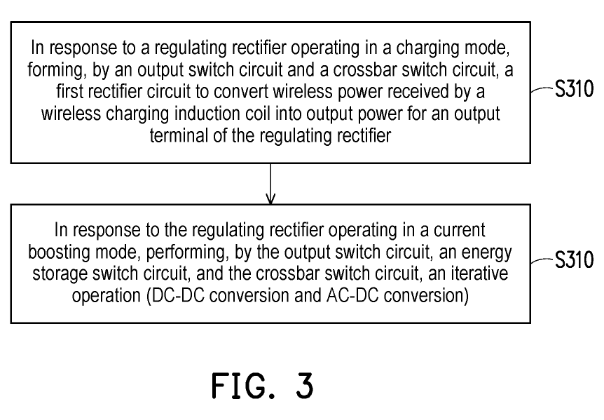

FIG. 3 is a schematic flow chart of an operation method of the regulating rectifier according to an embodiment of the disclosure. With reference to FIG. 2 and FIG. 3, in response to the regulating rectifier 200 operating in the charging mode (CHM), the output switch circuit 210 and the crossbar switch circuit 230 form a rectifier circuit (first rectifier circuit), so as to convert the wireless power received by the wireless charging induction coil 20 into the output power Eout2 for the output terminal of the regulating rectifier 200 (step S310).

In response to the regulating rectifier 200 operating in the current boosting mode (CBM), the output switch circuit 210, the energy storage switch circuit 220, and the crossbar switch circuit 230 perform an iterative operation together (step S320). The iterative operation at least includes a direct current-direct current (DC-DC) conversion and an alternating current-direct current (AC-DC) conversion. The DC-DC conversion uses stored energy of the energy storage capacitor Csto to perform current boosting on the wireless charging induction coil 20. That is, the energy storage switch circuit 220 transfers the stored energy of the energy storage capacitor Csto to the wireless charging induction coil 20. Next, the AC-DC conversion converts the wireless power (boosted power) of the wireless charging induction coil 20 into the output power Eout2 for the output terminal of the regulating rectifier 200.

In summary, the regulating rectifier 200 may operate in a plurality of modes, such as the charging mode and the current boosting mode. When the wireless power received by the wireless charging induction coil 20 is sufficiently large, the regulating circuit 200 may operate in the charging mode to convert the wireless power received by the wireless charging induction coil 20 into the output power Eout2 for other circuits (load circuit, not shown). When the wireless power received by the wireless charging induction coil 20 becomes weak, the regulating rectifier 200 may operate in the current boosting mode to perform the iterative operation, such as the DC-DC conversion and the AC-DC conversion. The current boosting mode may use the stored energy of the energy storage capacitor Csto to perform current boosting on the wireless charging induction coil 20 (transferring the energy of the energy storage capacitor Csto to the wireless charging induction coil 20) and then convert the boosted power of the wireless charging induction coil 20 into the output power Eout2. Therefore, the regulating rectifier 200 may effectively use the wireless charging power received by the wireless charging induction coil 20 and thereby provides a stable power supply voltage to the load circuit.

Based on practical design, in some application examples, the DC-DC conversion of the current boosting mode includes a first phase and a second phase. In the first phase, the energy storage switch circuit 220 uses the stored energy of the energy storage capacitor Csto to perform the current boosting on the wireless charging induction coil 20. In the second phase, the output switch circuit 210 outputs a current of the wireless charging induction coil 20 to the output terminal of the regulating rectifier 200.

In some application examples, the regulating rectifier 200 may also operate in a storing mode (STM) and a free-wheeling mode (FWM). In response to the regulating rectifier 200 operating in the storing mode, the energy storage switch circuit 220 and the crossbar switch circuit 230 form a second rectifier circuit together to store the wireless power of the wireless charging induction coil 20 in the energy storage capacitor Csto. In response to the regulating rectifier 200 operating in free-wheeling mode, the energy storage switch circuit 220 and the output switch circuit 210 are turned off, and the crossbar switch circuit 230 grounds the first terminal and the second terminal of the wireless charging induction coil 20.

In response to input power of the wireless power received by the wireless charging induction coil 20 being greater than output power at the output terminal of the regulating rectifier 200, the regulating rectifier 200 regulates an output voltage at the output terminal of the regulating rectifier 200 between a first threshold voltage and a second threshold voltage, where the first threshold voltage is greater than the second threshold voltage. The first threshold voltage and the second threshold voltage may be determined based on practical design and application. In response to the input power of the wireless charging induction coil 20 being less than the output power of the regulating rectifier 200, the regulating rectifier 200 regulates the output voltage at the output terminal of the regulating rectifier 200 between the second threshold voltage and a third threshold voltage, where the second threshold voltage is greater than the third threshold voltage. The third threshold voltage may be determined based on practical design and application.

In response to the input power of the wireless power received by the wireless charging induction coil 20 being greater than the output power at the output terminal of the regulating rectifier 200, the regulating rectifier 200 selectively operates in one of the charging mode, the storing mode, and the free-wheeling mode. In response to the input power being less than the output power, the regulating rectifier selectively operates in one of the charging mode and the current boosting mode, so as to generate the output power of the regulating rectifier 200 by using the wireless power received by the wireless charging induction coil 20 and the stored energy of the energy storage capacitor Csto.

In response to the output voltage at the output terminal of the regulating rectifier 200 being greater than the first threshold voltage, the regulating rectifier 200 enters the storing mode. In response to a stored voltage of the energy storage capacitor Csto being greater than the first threshold voltage, the regulating rectifier 200 enters the free-wheeling mode from the storing mode. In response to the output voltage of the regulating rectifier 200 being less than the second threshold voltage, the regulating rectifier 200 enters the charging mode from the free-wheeling mode.

In response to the output voltage at the output terminal of the regulating rectifier 200 being less than a hysteresis window defined by the first threshold voltage and the second threshold voltage, the regulating rectifier 200 enters the charging mode. In response to the output voltage of the regulating rectifier 200 being less than the third threshold voltage, the regulating rectifier 200 enters the current boosting mode from the charging mode. In response to the output voltage of the regulating rectifier 200 being greater than the first threshold voltage, the regulating rectifier 200 ends the current boosting mode.

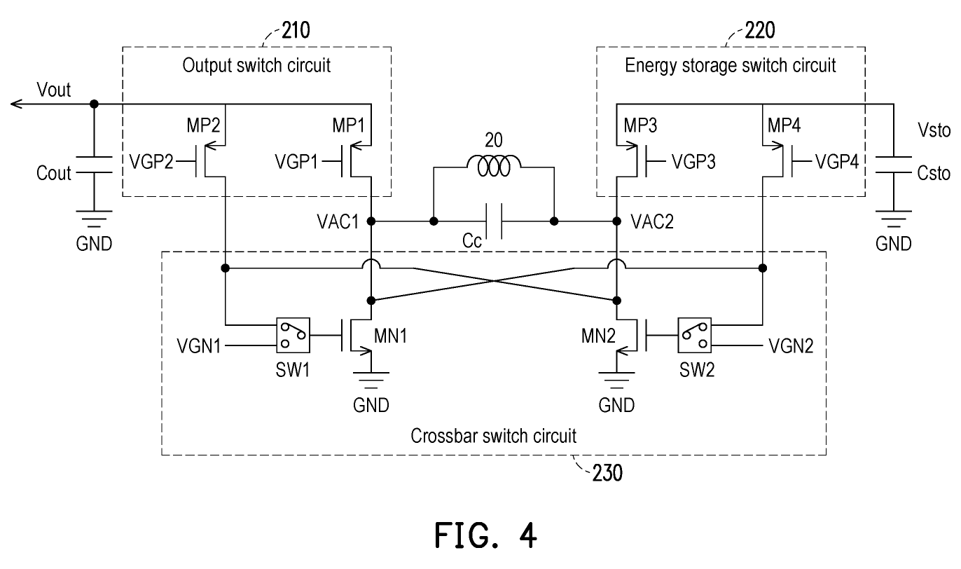

FIG. 4 is a schematic circuit diagram illustrating the output switch circuit 210, the energy storage switch circuit 220, and the crossbar switch circuit 230 according to an embodiment of the disclosure. The output switch circuit 210, the energy storage switch circuit 220, and the crossbar switch circuit 230 shown in FIG. 4 may act as one of the many embodiments of the output switch circuit 210, the energy storage switch circuit 220, and the crossbar switch circuit 230 shown in FIG. 2. In the embodiment shown in FIG. 4, the regulating rectifier further includes a resonant capacitor Cc and an output capacitor Cout. A first terminal of the resonant capacitor Cc is coupled to the first terminal of the wireless charging induction coil 20. A second terminal of the resonant capacitor Cc is coupled to the second terminal of the wireless charging induction coil 20. A first terminal of the output capacitor Cout is coupled to the common terminal of the output switch circuit 210. A second terminal of the output capacitor Cout is coupled to a reference voltage source (e.g., the ground voltage source GND).

In the embodiment shown in FIG. 4, the output switch circuit 210 includes a switch MP1 and a switch MP2. The switch MP1 is controlled by a control signal VGP1, while the switch MP2 is controlled by a control signal VGP2. A first terminal of the first switch MP1 is coupled to the first selection terminal of the output switch circuit 210, that is, coupled to the first terminal of the wireless charging induction coil 20. A second terminal of the switch MP1 is coupled to the common terminal of the output switch circuit 210. The common terminal of the output switch circuit 210 is used to provide an output voltage Vout to the load circuit (not shown). A first terminal of the switch MP2 is coupled to the second selection terminal of the output switch circuit 210, that is, coupled to the second terminal of the wireless charging induction coil 20. A second terminal of the switch MP2 is coupled to the common terminal of the output switch circuit 210.

In response to the regulating rectifier 200 operating in the charging mode, the switch MP1 and the switch MP2 are turned on in an alternating manner to convert AC power of the wireless charging induction coil 20 into DC power and output the DC power to the common terminal of the output switch circuit 210. In response to the regulating rectifier 200 operating in the current boosting mode and the crossbar switch circuit 230 performing the DC-DC conversion, one of the switches MP1 and MP2 is turned on while the other is turned off. The "crossbar switch circuit 230 performing the DC-DC conversion" is to be described in the following paragraphs.

In response to the regulating rectifier 200 operating in the current boosting mode and the crossbar switch circuit 230 performing the AC-DC conversion, the switches MP1 and MP2 are turned on in an alternating manner to convert the AC power of the wireless charging induction coil 20 into the DC power. The "crossbar switch circuit 230 performing the AC-DC conversion" is to be described in the following paragraphs. In response to the regulating rectifier 200 operating in the storing mode and the free-wheeling mode, the switches MP1 and MP2 are turned off.

In the embodiment shown in FIG. 4, the energy storage switch circuit 220 includes a switch MP3 and a switch MP4. The switch MP3 is controlled by a control signal VGP3, while the switch MP4 is controlled by a control signal VGP4. A first terminal of the switch MP4 is coupled to the first selection terminal of the energy storage switch circuit 220, that is, coupled to the first terminal of the wireless charging induction coil 20. A first terminal of the switch MP3 is coupled to the second selection terminal of the energy storage switch circuit 220, that is, coupled to the second terminal of the wireless charging induction coil 20. The switch MP3 and a second terminal of the MP4 are coupled to the common terminal of the energy storage switch circuit 220. A second terminal of the switch MP3 is coupled to the common terminal of the energy storage switch circuit 220, that is, coupled to the energy storage capacitor Csto. The first terminal of the energy storage capacitor Csto provides a stored voltage Vsto. The second terminal of the energy storage capacitor Csto is coupled to the reference voltage source (e.g., the ground voltage source GND).

In response to the regulating rectifier 200 operating in the charging mode, the switches MP3 and MP4 are turned off. In response to the regulating rectifier 200 operating in the current boosting mode and the crossbar switch circuit 230 performing the DC-DC conversion, one of the switches MP3 and MP4 is turned on while the other is turned off. The "crossbar switch circuit 230 performing the AC-DC conversion" is to be described in the following paragraphs. In response to the regulating rectifier 200 operating in the current boosting mode and the crossbar switch circuit 230 performing the AC-DC conversion, the switches MP3 and MP4 are turned off. The "crossbar switch circuit 230 performing the AC-DC conversion" is to be described in the following paragraphs. In response to the regulating rectifier 200 operating in the storing mode, the switches MP3 and MP4 are turned on in an alternating manner to convert the AC power of the wireless charging induction coil 20 into the DC power and store the DC power in the energy storage capacitor Csto. In response to the regulating rectifier 200 operating in the free-wheeling mode, the switches MP3 and MP4 are turned off.

In the embodiment shown in FIG. 4, the crossbar switch circuit 230 includes a switch MN1, a switch MN2, a switch SW1, and a switch SW2. A first terminal of the switch MN1 is coupled to the first terminal of the wireless charging induction coil 20. A first terminal of the switch MN2 is coupled to the second terminal of the wireless charging induction coil 20. The switch MN1 and a second terminal of the MN2 are coupled to the reference voltage source (e.g., the ground voltage source GND). The switch SW1 has a first selection terminal, a second selection terminal, and a common terminal. The common terminal of the switch SW1 is coupled to a control terminal of the switch MN1. The first selection terminal of the switch SW1 is coupled to the second terminal of the wireless charging induction coil 20. The second selection terminal of the switch SW1 receives a gate control signal VGN1. The switch SW2 has a first selection terminal, a second selection terminal, and a common terminal. The common terminal of the switch SW2 is coupled to a control terminal of the switch MN2. The first selection terminal of the switch SW2 is coupled to the first terminal of the wireless charging induction coil 20. The second selection terminal of the switch SW2 receives a gate control signal VGN2.

In response to the regulating rectifier 200 operating in the charging mode, the switch SW1 couples the second terminal of the wireless charging induction coil 20 to the control terminal of the switch MN1, and the switch SW2 couples the first terminal of the wireless charging induction coil 20 to the control terminal of the switch MN2. Herein, the switch MN1 is controlled by an AC voltage VAC2 at the second terminal of the wireless charging induction coil 20, while the switch MN2 is controlled by an AC voltage VAC1 at the first terminal of the wireless charging induction coil 20.

In response to the regulating rectifier 200 operating in the current boosting mode and the crossbar switch circuit 230 performing the DC-DC conversion, the switch SW1 transmits the gate control signal VGN1 to the control terminal of the switch MN1, and the switch SW2 transmits the gate control signal VGN2 to the control terminal of the switch MN2. Herein, the switch MN1 is controlled by the control signal VGN1, while the switch MN2 is controlled by the control signal VGN2. In the DC-DC conversion of the current boosting mode, one of the switches MN1 and MN2 is turned on while the other is turned off. For instance, the DC-DC conversion in the current boosting mode includes the first phase and the second phase. In the first phase, the switch MN1 is turned on while the switch MN2 is turned off, so as to use the stored energy of the energy storage capacitor Csto for current boosting of the wireless charging induction coil 20. In the second phase, the switch MN1 is turned off while the switch MN2 is turned on, so as to output the current of the wireless charging induction coil 20 to the output terminal of the regulating rectifier 200.

In response to the regulating rectifier 200 operating in the current boosting mode and the crossbar switch circuit performing the AC-DC conversion, the switch SW1 couples the second terminal of the wireless charging induction coil 20 to the control terminal of the switch MN1, and the switch SW2 couples the first terminal of the wireless charging induction coil 20 to the control terminal of the switch MN2. Herein, the switch MN1 is controlled by the AC voltage VAC2 at the second terminal of the wireless charging induction coil 20, while the switch MN2 is controlled by the AC voltage VAC1 at the first terminal of the wireless charging induction coil 20.

In response to the regulating rectifier 200 operating in the storing mode, the switch SW1 couples the second terminal of the wireless charging induction coil 20 to the control terminal of the switch MN1, and the switch SW2 couples the first terminal of the wireless charging induction coil 20 to the control terminal of the switch MN2. Herein, the switch MN1 is controlled by the AC voltage VAC2 at the second terminal of the wireless charging induction coil 20, while the switch MN2 is controlled by the AC voltage VAC1 at the first terminal of the wireless charging induction coil 20.

In response to the regulating rectifier 200 operating in the free-wheeling mode, the switch SW1 transmits the gate control signal VGN1 to the control terminal of the switch MN1, and the switch SW2 transmits the gate control signal VGN2 to the control terminal of the switch MN2, to turn on the switches SW1 and SW2.

In summary, the switches MN1 and MN2 may automatically switch between cross-coupling and gate-driving control, while the switches MP1, MP2, MP3, and MP4 may respectively generate two outputs (the output voltage Vout and the stored voltage Vsto). Herein, the output voltage Vout has the priority to charge. Therefore, while providing a stable output voltage Vout, the regulating rectifier 200 may effectively store excess energy into the energy storage capacitor Csto and reuse the energy stored in the energy storage capacitor Csto when needed.

When received power of the wireless charging induction coil 20 is sufficient, a system may control the regulating rectifier 200 to enter the charging mode first and provide the output voltage Vout through a rectifier. For instance, in the charging mode, the switch MN1 is controlled by the AC voltage VAC2 at the second terminal of the wireless charging induction coil 20, while the switch MN2 is controlled by the AC voltage VAC1 at the first terminal of the wireless charging induction coil 20. In a first AC phase, the switches MP1 and MN2 are turned on while the switches MP2, MP3, MP4, and MN1 are turned off, allowing the current of the wireless charging induction coil 20 to be output to the output terminal of the regulating rectifier 200. In a second AC phase, the switches MP2 and MN1 are turned on while the switches MP1, MP3, MP4, and MN2 are turned off, allowing the current of the wireless charging induction coil 20 to be output to the output terminal of the regulating rectifier 200.

When the output voltage Vout reaches a target voltage, the system may switch an operation mode of the regulating rectifier 200 to the storing mode. Through the operation of the rectifier, the regulating rectifier 200 stores the excess received power from the wireless charging induction coil 20 in the energy storage capacitor Csto as backup energy. For instance, in the storing mode, the switch MN1 is controlled by the AC voltage VAC2 at the second terminal of the wireless charging induction coil 20, while the switch MN2 is controlled by the AC voltage VAC1 at the first terminal of the wireless charging induction coil 20. In the first AC phase, the switches MP3 and MN1 are turned on while the switches MP1, MP2, MP4, and MN2 are turned off, allowing the current of the wireless charging induction coil 20 to be output to the energy storage capacitor Csto. In the second AC phase, the switches MP4 and MN2 are turned on while the switches MP1, MP2, MP3, and MN1 are turned off, allowing the current of the wireless charging induction coil 20 to be output to the energy storage capacitor Csto.

When the output voltage Vout reaches the target voltage and the energy storage capacitor Csto is fully charged, the system may control the regulating rectifier 200 to enter the free-wheeling mode to stop providing the output voltage Vout and the stored voltage Vsto. For instance, in the free-wheeling mode, the switch MN1 is controlled by the control signal VGN1 to remain turned on, while the switch MN2 is controlled by the control signal VGN2 to remain turned on. The switches MP1, MP2, MP3, and MP4 all remain turned off in the free-wheeling mode.

When the received power of the wireless charging induction coil 20 is insufficient to support the output load, the system may control the regulating rectifier 200 to enter the current boosting mode. In the current boosting mode, the regulating rectifier 200 is controlled to use the backup energy of the energy storage capacitor Csto to increase the output current of the regulating rectifier 200, in order to maintain the voltage regulation function for the output voltage Vout. The iterative operation performed by the regulating rectifier 200 in the current boosting mode includes the DC-DC conversion and the AC-DC conversion, where the DC-DC conversion includes the first phase and the second phase. In the current boosting mode, the switch MN1 is controlled by the control signal VGN1, while the switch MN2 is controlled by the control signal VGN2. In the first phase, the switches MP3 and MN1 are turned on while the switches MP1, MP2, MP4, and MN2 are turned off, allowing the current of the energy storage capacitor Csto to be output to the wireless charging induction coil 20. In the second phase, the switches MP1 and MN2 are turned on while the switches MP2, MP3, MP4, and MN1 are turned off, allowing the current of the wireless charging induction coil 20 to be output to the output terminal of the regulating rectifier 200. The operation of the regulating rectifier 200 in the AC-DC conversion may refer to the related description of the charging mode, so description thereof is not repeated herein.

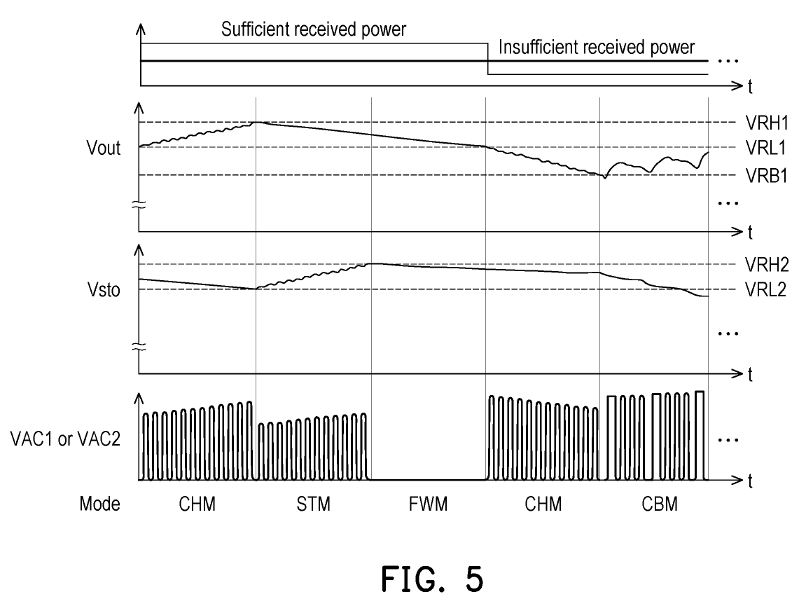

FIG. 5 is a waveform graph illustrating voltages in different operation modes according to an embodiment of the disclosure. The horizontal axis of FIG. 5 represents time t. The operation presented in FIG. 5 includes a voltage regulation mechanism composed of three threshold voltages VRH1, VRL1, and VRB1 (VRH1 > VRL1 > VRB1), to implement automatic detection of received power magnitude and timely activation of the current boosting mode. The voltage regulation of the stored voltage Vsto is implemented through two threshold voltages VRH2 and VRL2 (VRH2 > VRL2). The system adopts an energy reuse design, prioritizing the voltage regulation requirement of the output voltage Vout, and excess energy is stored in the energy storage capacitor Csto.

The system operation is divided into two states: "sufficient received power" and "insufficient received power". When the received power of the wireless charging induction coil 20 is sufficient, the output voltage Vout is regulated between the threshold voltage VRH1 and the threshold voltage VRL1. The threshold voltages VRH1 and VRL1 define a hysteresis window. In the "sufficient received power" state, the operation mode of the regulating rectifier 200 is switched among the charging mode CHM, the storing mode STM, and the free-wheeling mode FWM, to maintain the voltage regulation state of the output voltage Vout and the stored voltage Vsto. These mode switches are performed when the received power of the wireless charging induction coil 20 is sufficient to meet the load demand.

When the output voltage Vout falls below the threshold voltage VRL1, the regulating rectifier 200 enters the charging mode CHM to charge the output capacitor Cout until the output voltage Vout exceeds the threshold voltage VRH1 and then ends the charging. In response to the regulating rectifier 200 operating in the charging mode CHM, the output switch circuit 210 and the crossbar switch circuit 230 form a rectifier circuit, so as to convert the wireless power received by the wireless charging induction coil 20 into the output voltage Vout for the energy storage capacitor Csto. To be specific, when the regulating rectifier 200 operates in the charging mode, the switches MP1 and MP2 are turned on (other switches are turned off) in an alternating manner, so as to convert the AC power of the wireless charging induction coil 20 into DC power and output the DC power to the energy storage capacitor Csto.

If the output capacitor Cout does not need to be charged and the stored voltage Vsto is below the threshold voltage VRL2, the regulating rectifier 200 enters the storing mode STM to charge the energy storage capacitor Csto until the stored voltage Vsto exceeds VRH2 and then ends the storing mode. If neither the output capacitor Cout nor the energy storage capacitor Csto needs to be charged, the regulating rectifier 200 enters the free-wheeling mode FWM to stop charging the two. To be specific, in response to the stored voltage Vsto of the energy storage capacitor Csto being greater than the threshold voltage VRH2, the regulating rectifier 200 enters the free-wheeling mode FWM from the storing mode STM. In response to the output voltage Vout of the regulating rectifier 200 being less than the hysteresis window defined by the threshold voltages VRH1 and VRL1, the regulating rectifier 200 returns to the charging mode CHM from the free-wheeling mode FWM.

When the received power of the wireless charging induction coil 20 is insufficient, the output voltage Vout drops from the original hysteresis window formed by the threshold voltages VRH1 and VRL1 to between the threshold voltage VRL1 and the threshold voltage VRB1. In the "insufficient received power" state, the regulating rectifier 200 periodically switches to the current boosting mode CBM based on the charging mode CHM to compensate for the insufficient received power of the wireless charging induction coil 20. To be specific, when the output voltage Vout falls below the threshold voltage VRB1, the regulating rectifier 200 enters the current boosting mode CBM from the charging mode CHM to charge the output capacitor Cout. In addition to the wireless power received by the wireless charging induction coil 20, the regulating rectifier 200 in the current boosting mode CBM also uses the energy in the energy storage capacitor Csto to supplement the energy of the wireless charging induction coil 20, allowing the output voltage Vout to gradually rise. Only when the output voltage Vout exceeds the threshold voltage VRL1 does the regulating rectifier 200 end the current boosting mode CBM and switch back to the charging mode CHM.

When changes in the transmission environment lead to temporary insufficient received power, even if all the received power from the wireless charging induction coil 20 is used to charge the output voltage Vout, the output voltage Vout may continue to drop. By detecting whether the output voltage Vout is below the threshold voltage VRB1, detection may be implemented to activate the current boosting mode. Herein, the regulating rectifier 200 operates in the charging mode and the current boosting mode to charge the output voltage Vout. Therefore, when the received power of the wireless charging induction coil 20 is again sufficient to support the output power, the output voltage Vout continues to be charged and increase until the output voltage Vout reaches the threshold voltage VRH1.

If the received power of the wireless charging induction coil 20 is still insufficient to support the load, the output voltage Vout may continue to decrease in the charging mode until it falls below the threshold voltage VRB1 again and restarts the current boosting mode. Conversely, when the received power is sufficient, the output voltage Vout gradually increases until it exceeds the threshold voltage VRH1 and then ends the charging mode, and switches to the storing mode or the free-wheeling mode according to system requirements.

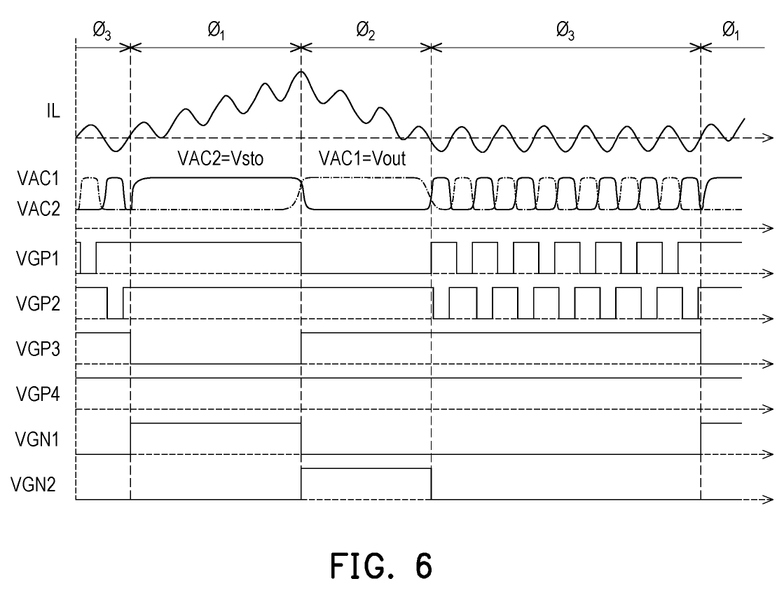

FIG. 6 is a waveform graph illustrating voltages in a current boosting mode according to an embodiment of the disclosure. The horizontal axis of FIG. 6 represents time. The current boosting mode is used when the received power is insufficient to support the output power, where the energy stored in the energy storage capacitor Csto may be injected into an original inductor current IL, so that a charging current for the output voltage Vout is boosted. The iterative operation performed in the current boosting mode includes a DC-DC conversion and an AC-DC conversion Ø3, where the DC-DC conversion includes a first phase Ø1 and a second phase Ø2. Referring to FIG. 4 and FIG. 6, in the first phase Ø1, the control signals VGN1 and VGN2 control the switch MN1 and a switch MN. The switches MP3 and MN1 are turned on based on the control of the control signals VGP1 and VGN1 (while the remaining switches remain turned off). Herein, the energy in the energy storage capacitor Csto is transferred to the wireless charging induction coil 20 to boost the inductor current IL.

In the second phase Ø2, gates of the switches MN1 and MN2 continue to be controlled by the control signals VGN1 and VGN2. Herein, the control signals VGP1 and VGN2 turn on the switches MP1 and MN2, while the remaining switches remain turned off. The energy accumulated on the wireless charging induction coil 20 during the first phase Ø1 is released to the output capacitor Cout. That is, the inductor current IL charges the output voltage Vout through a charging path formed by the switches MP1 and MN2. Herein, the charging current to the output capacitor Cout no longer relies solely on the AC power received by the wireless charging induction coil 20, but can use the energy in the energy storage capacitor Csto to supplement charge to the output capacitor Cout (further boosting the charging current to the output voltage Vout).

Finally, in the AC-DC conversion Ø3, the gates of the switches MN1 and MN2 are switched to cross-coupled control, that is, the switch MN1 is controlled by the AC voltage VAC2, while the switch MN2 is controlled by the AC voltage VAC1. In this stage, the circuit operates like the rectification operation in the charging mode (refer to the related description of the charging mode). The charging mode (AC-DC conversion Ø3) converts the AC power received by the wireless charging induction coil 20 from AC to DC to charge the output capacitor Cout.

Adjusting the duration of the first phase Ø1 may control the magnitude of the boost in the inductor current IL. In other words, the longer the first phase Ø1 lasts, the more energy from the energy storage capacitor Csto may be transferred to the wireless charging induction coil 20, and the inductor current IL and the output charging current are thereby further boosted. When the first phase Ø1 ends, the system (control circuit, not shown) triggers the start of the second phase Ø2, and the end time of the second phase Ø2 is determined by the control circuit detecting when the inductor current IL drops to zero. Subsequently, it enters the AC-DC conversion Ø3, and the end of the AC-DC conversion Ø3 is determined by the control circuit determining when to trigger the first phase Ø1 again.

In view of the foregoing, in the above embodiments, a regulating rectifier 20 with an adaptive current boosting function is provided, in which the energy in the energy storage capacitor Csto may be used to enhance the output charging current, and the charging ability to the output is thereby boosted. When the received power is sufficient, it operates similarly to a conventional single-stage regulating rectifier, but the system may adaptively activate this current boosting mode based on the current input power condition. This technique is applicable to various scenarios with short-term insufficient received power and is not limited by the relationship between the stored voltage Vsto and the output voltage Vout. Therefore, the input power may be efficiently used, the ability to withstand input power variations is further enhanced, the maximum supportable output power is expanded, and flexible circuit specification design is achieved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A regulating rectifier, comprising:
an output switch circuit having a first selection terminal, a second selection terminal, and a common terminal, wherein the common terminal of the output switch circuit is coupled to an output terminal of the regulating rectifier, a first terminal and a second terminal of an input terminal pair of the regulating rectifier are respectively coupled to a first terminal and a second terminal of a wireless charging induction coil, the first selection terminal of the output switch circuit is coupled to the first terminal of the wireless charging sensing coil, and the second selection terminal of the output switch circuit is coupled to the second terminal of the wireless charging induction coil;
an energy storage switch circuit having a first selection terminal, a second selection terminal, and a common terminal, wherein the first selection terminal of the energy storage switch circuit is coupled to the first terminal of the wireless charging sensing coil, and the second selection terminal of the energy storage switch circuit is coupled to the second terminal of the wireless charging induction coil;
an energy storage capacitor, wherein a first terminal of the energy storage capacitor is coupled to the common terminal of the energy storage switch circuit, and a second terminal of the energy storage capacitor is coupled to a first reference voltage source; and
a crossbar switch circuit having a first terminal and a second terminal, wherein the first terminal of the crossbar switch circuit is coupled to the first terminal of the wireless charging induction coil, and the second terminal of the crossbar switch circuit is coupled to the second terminal of the wireless charging induction coil,
in response to the regulating rectifier operating in a charging mode, the output switch circuit and the crossbar switch circuit form a first rectifier circuit together to convert wireless power received by the wireless charging induction coil into output power for the output terminal of the regulating rectifier, and
in response to the regulating rectifier operating in a current boosting mode, the output switch circuit, the energy storage switch circuit, and the crossbar switch circuit perform an iterative operation together, wherein the iterative operation comprises a direct current-direct current (DC-DC) conversion and an alternating current-direct current (AC-DC) conversion, the DC-DC conversion uses stored energy of the energy storage capacitor to perform current boosting on the wireless charging induction coil, and the AC-DC conversion converts the wireless power of the wireless charging induction coil into the output power for the output terminal of the regulating rectifier.

2. The regulating rectifier according to claim 1, wherein the DC-DC conversion of the current boosting mode comprises a first phase and a second phase, in the first phase, the energy storage switch circuit uses the stored energy of the energy storage capacitor to perform the current boosting on the wireless charging induction coil, and in the second phase, the output switch circuit outputs a current of the wireless charging induction coil to the output terminal of the regulating rectifier.

3. The regulating rectifier according to claim 1, wherein
in response to the regulating rectifier operating in a storing mode, the energy storage switch circuit and the crossbar switch circuit form a second rectifier circuit together to store the wireless power of the wireless charging induction coil in the energy storage capacitor, and
in response to the regulating rectifier operating in a free-wheeling mode, the energy storage switch circuit and the output switch circuit are turned off, and the crossbar switch circuit grounds the first terminal and the second terminal of the wireless charging induction coil.

4. The regulating rectifier according to claim 1, wherein
in response to an input power of the wireless power received by the wireless charging induction coil being greater than an output power at the output terminal of the regulating rectifier, the regulating rectifier regulates an output voltage at the output terminal of the regulating rectifier between a first threshold voltage and a second threshold voltage, and the first threshold voltage is greater than the second threshold voltage, and
in response to the input power being less than the output power, the regulating rectifier regulates the output voltage at the output terminal of the regulating rectifier between the second threshold voltage and a third threshold voltage, and the second threshold voltage is greater than the third threshold voltage.

5. The regulating rectifier according to claim 1, wherein
in response to an input power of the wireless power received by the wireless charging induction coil being greater than an output power at the output terminal of the regulating rectifier, the regulating rectifier selectively operates in one of the charging mode, a storing mode, and a free-wheeling mode, and
in response to the input power being less than the output power, the regulating rectifier selectively operates in one of the charging mode and the current boosting mode, so as to generate the output power using the wireless power received by the wireless charging induction coil and the stored energy of the energy storage capacitor.

6. The regulating rectifier according to claim 5, wherein
in response to an output voltage at the output terminal of the regulating rectifier being greater than a first threshold voltage, the regulating rectifier enters the storing mode,
in response to a stored voltage of the energy storage capacitor being greater than the first threshold voltage, the regulating rectifier enters the free-wheeling mode from the storing mode, wherein the first threshold voltage is greater than the second threshold voltage, and
in response to the output voltage being less than the second threshold voltage, the regulating rectifier enters the charging mode from the free-wheeling mode.

7. The regulating rectifier according to claim 5, wherein
in response to an output voltage at the output terminal of the regulating rectifier being less than a hysteresis window defined by a first threshold voltage and a second threshold voltage, the regulating rectifier enters the charging mode, wherein the first threshold voltage is greater than the second threshold voltage,
in response to the output voltage being less than a third threshold voltage, the regulating rectifier enters the current boosting mode from the charging mode, wherein the second threshold voltage is greater than the third threshold voltage, and
in response to the output voltage being greater than the first threshold voltage, the regulating rectifier ends the current boosting mode.

8. The regulating rectifier according to claim 1, further comprising:
a resonant capacitor, wherein a first terminal of the resonant capacitor is coupled to the first terminal of the wireless charging induction coil, and a second terminal of the resonant capacitor is coupled to the second terminal of the wireless charging induction coil.

9. The regulating rectifier according to claim 1, further comprising:
an output capacitor, wherein a first terminal of the output capacitor is coupled to the common terminal of the output switch circuit, and a second terminal of the output capacitor is coupled to a second reference voltage source.

10. The regulating rectifier according to claim 1, wherein the output switch circuit comprises:
a first switch, wherein a first terminal of the first switch is coupled to the first selection terminal of the output switch circuit, and a second terminal of the first switch is coupled to the common terminal of the output switch circuit; and
a second switch, wherein a first terminal of the second switch is coupled to the second selection terminal of the output switch circuit, and a second terminal of the second switch is coupled to the common terminal of the output switch circuit,
in response to the regulating rectifier operating in the charging mode, the first switch and the second switch are turned on in an alternating manner to convert AC power from the wireless charging induction coil into DC power and output the DC power to the common terminal of the output switch circuit,
in response to the regulating rectifier operating in the current boosting mode and the crossbar switch circuit performing the DC-DC conversion, one of the first switch and the second switch is turned on while the other is turned off, and
in response to the regulating rectifier operating in the current boosting mode and the crossbar switch circuit performing the AC-DC conversion, the first switch and the second switch are turned on in alternating manner to convert the AC power from the wireless charging induction coil into the DC power.

11. The regulating rectifier according to claim 10, wherein
in response to the regulating rectifier operating in a storage mode, the first switch and the second switch are turned off, and
in response to the regulating rectifier operating in a free-wheeling mode, the first switch and the second switch are turned off.

12. The regulating rectifier according to claim 1, wherein the energy storage switch circuit comprises:
a first switch, wherein a first terminal of the first switch is coupled to the first selection terminal of the energy storage switch circuit, and a second terminal of the first switch is coupled to the common terminal of the energy storage switch circuit; and
a second switch, wherein a first terminal of the second switch is coupled to the second selection terminal of the energy storage switch circuit, and a second terminal of the second switch is coupled to the common terminal of the energy storage switch circuit,
in response to the regulating rectifier operating in the charging mode, the first switch and the second switch are turned off,
in response to the regulating rectifier operating in the current boosting mode and the crossbar switch circuit performing the DC-DC conversion, one of the first switch and the second switch is turned on while the other is turned off, and
in response to the regulating rectifier operating in the current boosting mode and the crossbar switch circuit performing the AC-DC conversion, the first switch and the second switch are turned off.

13. The regulating rectifier according to claim 12, wherein
in response to the regulating rectifier operating in a storing mode, the first switch and the second switch are turned on in an alternating manner to convert AC power from the wireless charging induction coil into DC power and store the DC power in the energy storage capacitor, and
in response to the regulating rectifier operating in a free-wheeling mode, the first switch and the second switch are turned off.

14. The regulating rectifier according to claim 1, wherein the crossbar switch circuit comprises:
a first switch, wherein a first terminal of the first switch is coupled to the first terminal of the wireless charging induction coil, and a second terminal of the first switch is coupled to a second reference voltage source;
a second switch, wherein a first terminal of the second switch is coupled to the second terminal of the wireless charging induction coil, and a second terminal of the second switch is coupled to a third reference voltage source;
a third switch having a first selection terminal, a second selection terminal, and a common terminal, wherein the common terminal of the third switch is coupled to a control terminal of the first switch, the first selection terminal of the third switch is coupled to the second terminal of the wireless charging induction coil, and the second selection terminal of the third switch receives a first gate control signal; and
a fourth switch having a first selection terminal, a second selection terminal, and a common terminal, wherein the common terminal of the fourth switch is coupled to a control terminal of the second switch, the first selection terminal of the fourth switch is coupled to the first terminal of the wireless charging induction coil, and the second selection terminal of the fourth switch receives a second gate control signal, wherein
in response to the regulating rectifier operating in the charging mode, the third switch couples the second terminal of the wireless charging induction coil to the control terminal of the first switch, and the fourth switch couples the first terminal of the wireless charging induction coil to the control terminal of the second switch,
in response to the regulating rectifier operating in the current boosting mode and the crossbar switch circuit performing the DC-DC conversion, the third switch transmits the first gate control signal to the control terminal of the first switch, and the fourth switch transmits the second gate control signal to the control terminal of the second switch; and
in response to the regulating rectifier operating in the current boosting mode and the crossbar switch circuit performing the AC-DC conversion, the third switch couples the second terminal of the wireless charging induction coil to the control terminal of the first switch, and the fourth switch couples the first terminal of the wireless charging induction coil to the control terminal of the second switch.

15. The regulating rectifier according to claim 14, wherein in the DC-DC conversion of the current boosting mode, one of the first switch and the second switch is turned on while the other is turned off.

16. The regulating rectifier according to claim 14, wherein the DC-DC conversion of the current boosting mode comprises a first phase and a second phase, in the first phase, the first switch is turned on while the second switch is turned off to use the stored energy of the energy storage capacitor to perform the current boosting on the wireless charging induction coil, and in the second phase, the first switch is turned off while the second switch is turned on to output a current of the wireless charging induction coil to the output terminal of the regulating rectifier.

17. The regulating rectifier according to claim 14, wherein
in response to the regulating rectifier operating in a storing mode, the third switch couples the second terminal of the wireless charging induction coil to the control terminal of the first switch, and the fourth switch couples the first terminal of the wireless charging induction coil to the control terminal of the second switch, and
in response to the regulating rectifier operating in a free-wheeling mode, the third switch transmits the first gate control signal to the control terminal of the first switch, and the fourth switch transmits the second gate control signal to the control terminal of the second switch, so as to turn on the third switch and the fourth switch.

18. An operation method of a regulating rectifier, comprising:
in response to the regulating rectifier operating in a charging mode, forming, by an output switch circuit of the regulating rectifier and a crossbar switch circuit of the regulating rectifier, a first rectifier circuit to convert wireless power received by a wireless charging induction coil into output power for an output terminal of the regulating rectifier, wherein a first selection terminal of the output switch circuit and a first terminal of the crossbar switch circuit are coupled to a first terminal of the wireless charging induction coil, and a second selection terminal of the output switch circuit and a second terminal of the crossbar switch circuit are coupled to a second terminal of the wireless charging induction coil, a common terminal of the output switch circuit is coupled to the output terminal of the regulating rectifier, a first selection terminal of an energy storage switch circuit of the regulating rectifier is coupled to the first terminal of the wireless charging induction coil, a second selection terminal of the energy storage switch circuit is coupled to the second terminal of the wireless charging induction coil, a first terminal of an energy storage capacitor of the regulating rectifier is coupled to a common terminal of the energy storage switch circuit, and a second terminal of the energy storage capacitor is coupled to a first reference voltage source; and
in response to the regulating rectifier operating in a current boosting mode, performing, by the output switch circuit, the energy storage switch circuit, and the crossbar switch circuit of the regulating rectifier, an iterative operation, wherein the iterative operation comprises a direct current-direct current (DC-DC) conversion and an alternating current-direct current (AC-DC) conversion, the DC-DC conversion uses stored energy of the energy storage capacitor to perform current boosting on the wireless charging induction coil, and the AC-DC conversion converts the wireless power of the wireless charging induction coil into the output power for the output terminal of the regulating rectifier.

19. The operation method according to claim 18, wherein the DC-DC conversion of the current boosting mode comprises a first phase and a second phase, and the operation method further comprises:
using, by the energy storage switch circuit, the stored energy of the energy storage capacitor in the first phase to perform the current boosting on the wireless charging induction coil; and
outputting, by the output switch circuit, a current of the wireless charging induction coil in the second phase to the output terminal of the regulating rectifier.

20. The operation method according to claim 18, further comprising:
in response to the regulating rectifier operating in a storing mode, forming, by the energy storage switch circuit and the crossbar switch circuit, a second rectifier circuit to store the wireless power of the wireless charging induction coil in the energy storage capacitor; and
in response to the regulating rectifier operating in a free-wheeling mode, turning off the energy storage switch circuit and the output switch circuit and grounding, by the crossbar switch circuit, the first terminal and the second terminal of the wireless charging induction coil.

21. The operation method according to claim 18, further comprising:
in response to an input power of the wireless power received by the wireless charging induction coil being greater than an output power at the output terminal of the regulating rectifier, regulating, by the regulating rectifier, an output voltage at the output terminal of the regulating rectifier between a first threshold voltage and a second threshold voltage, wherein the first threshold voltage is greater than the second threshold voltage; and
in response to the input power being less than the output power, regulating, by the regulating rectifier, the output voltage at the output terminal of the regulating rectifier between the second threshold voltage and a third threshold voltage, wherein the second threshold voltage is greater than the third threshold voltage.

22. The operation method according to claim 18, further comprising:
in response to an input power of the wireless power received by the wireless charging induction coil being greater than an output power at the output terminal of the regulating rectifier, selectively operating, by the regulating rectifier, in one of the charging mode, a storing mode, and a free-wheeling mode; and
in response to the input power being less than the output power, selectively operating, by the regulating rectifier, in one of the charging mode and the current boosting mode, so as to generate the output power using the wireless power received by the wireless charging induction coil and the stored energy of the energy storage capacitor.

23. The operation method according to claim 22, further comprising:
in response to an output voltage at the output terminal of the regulating rectifier being greater than a first threshold voltage, enabling the regulating rectifier to enter the storing mode;
in response to a stored voltage of the energy storage capacitor being greater than the first threshold voltage, enabling the regulating rectifier to enter the free-wheeling mode from the storing mode, wherein the first threshold voltage is greater than the second threshold voltage; and
in response to the output voltage being less than the second threshold voltage, enabling the regulating rectifier to enter the charging mode from the free-wheeling mode.

24. The operation method according to claim 22, further comprising:
in response to an output voltage at the output terminal of the regulating rectifier being less than a hysteresis window defined by a first threshold voltage and a second threshold voltage, enabling the regulating rectifier to enter the charging mode, wherein the first threshold voltage is greater than the second threshold voltage,
in response to the output voltage being less than a third threshold voltage, enabling the regulating rectifier to enter the current boosting mode from the charging mode, wherein the second threshold voltage is greater than the third threshold voltage; and
in response to the output voltage being greater than the first threshold voltage, enabling the regulating rectifier to end the current boosting mode.

25. The operation method according to claim 18, further comprising:
in response to the regulating rectifier operating in the charging mode, turning on a first switch and a second switch of the output switch circuit in an alternating manner to convert AC power from the wireless charging induction coil into DC power and output the DC power to the common terminal of the output switch circuit, wherein a first terminal of the first switch is coupled to the first selection terminal of the output switch circuit, a second terminal of the first switch is coupled to the common terminal of the output switch circuit, a first terminal of the second switch is coupled to the second selection terminal of the output switch circuit, and a second terminal of the second switch is coupled to the common terminal of the output switch circuit;
in response to the regulating rectifier operating in the current boosting mode and the crossbar switch circuit performing the DC-DC conversion, turning on one of the first switch and the second switch while turning off the other; and
in response to the regulating rectifier operating in the current boosting mode and the crossbar switch circuit performing the AC-DC conversion, turning on the first switch and the second switch in alternating manner to convert the AC power from the wireless charging induction coil into the DC power.

26. The operation method according to claim 25, further comprising:
in response to the regulating rectifier operating in a storage mode, turning off the first switch and the second switch are; and
in response to the regulating rectifier operating in a free-wheeling mode, turning off the first switch and the second switch.

27. The operation method according to claim 18, further comprising:
in response to the regulating rectifier operating in the charging mode, turning off a first switch and a second switch of the energy storage switch circuit, wherein a first terminal of the first switch is coupled to the first selection terminal of the energy storage switch circuit, a second terminal of the first switch is coupled to the common terminal of the energy storage switch circuit, a first terminal of the second switch is coupled to the second selection terminal of the energy storage switch circuit, and a second terminal of the second switch is coupled to the common terminal of the energy storage switch circuit;
in response to the regulating rectifier operating in the current boosting mode and the crossbar switch circuit performing the DC-DC conversion, turning on one of the first switch and the second switch while turning off the other; and
in response to the regulating rectifier operating in the current boosting mode and the crossbar switch circuit performing the AC-DC conversion, turning off the first switch and the second switch.

28. The operation method according to claim 27, further comprising:
in response to the regulating rectifier operating in a storing mode, turning on the first switch and the second switch in an alternating manner to convert AC power from the wireless charging induction coil into DC power and store the DC power in the energy storage capacitor; and
in response to the regulating rectifier operating in a free-wheeling mode, turning off the first switch and the second switch.

29. The operation method according to claim 18, wherein the crossbar switch circuit comprises a first switch, a second switch, a third switch, and a fourth switch, and the operation method further comprises:
in response to the regulating rectifier operating in the charging mode, coupling, by the third switch, the second terminal of the wireless charging induction coil to the control terminal of the first switch, and coupling, by the fourth switch, the first terminal of the wireless charging induction coil to the control terminal of the second switch, wherein a first terminal of the first switch is coupled to the first terminal of the wireless charging induction coil, a second terminal of the first switch is coupled to a second reference voltage source, a first terminal of the second switch is coupled to the second terminal of the wireless charging induction coil, a second terminal of the second switch is coupled to a third reference voltage source, a common terminal of the third switch is coupled to a control terminal of the first switch, a first selection terminal of the third switch is coupled to the second terminal of the wireless charging induction coil, a second selection terminal of the third switch receives a first gate control signal, a common terminal of the fourth switch is coupled to a control terminal of the second switch, the first selection terminal of the fourth switch is coupled to a first terminal of the wireless charging induction coil, and a second selection terminal of the fourth switch receives a second gate control signal;
in response to the regulating rectifier operating in the current boosting mode and the crossbar switch circuit performing the DC-DC conversion, transmitting, by the third switch, the first gate control signal to the control terminal of the first switch, and transmitting, by the fourth switch, the second gate control signal to the control terminal of the second switch; and
in response to the regulating rectifier operating in the current boosting mode and the crossbar switch circuit performing the AC-DC conversion, coupling, by the third switch, the second terminal of the wireless charging induction coil to the control terminal of the first switch, and coupling, by the fourth switch, the first terminal of the wireless charging induction coil to the control terminal of the second switch.

30. The operation method according to claim 29, further comprising:
in the DC-DC conversion of the current boosting mode, turning on one of the first switch and the second switch while turning off the other.

31. The operation method according to claim 29, wherein the DC-DC conversion of the current boosting mode comprises a first phase and a second phase, and the operation method further comprises:
turning on the first switch while turning off the second switch in the first phase to use the stored energy of the energy storage capacitor to perform the current boosting on the wireless charging induction coil; and
turning off the first switch while turning on the second switch in the second phase to output a current of the wireless charging induction coil to the output terminal of the regulating rectifier.

32. The operation method according to claim 29, further comprising:
in response to the regulating rectifier operating in a storing mode, coupling, by the third switch, the second terminal of the wireless charging induction coil to the control terminal of the first switch, and coupling, by the fourth switch, the first terminal of the wireless charging induction coil to the control terminal of the second switch; and
in response to the regulating rectifier operating in a free-wheeling mode, transmitting, by the third switch, the first gate control signal to the control terminal of the first switch, and transmitting, by the fourth switch, the second gate control signal to the control terminal of the second switch, so as to turn on the third switch and the fourth switch.
